(19) United States
(12) Patent Application Publication
(10) Pub. No.: US 2025/0054986 A1
(43) Pub. Date: Feb. 13, 2025

(54) A POSITIVE ELECTRODE ACTIVE MATERIAL FOR SOLID-STATE RECHARGEABLE BATTERIES

(71) Applicant: Umicore, Brussels (BE)

(72) Inventors: Shinichi KUMAKURA, Olen (BE); JiHoon KANG, Chungcheongnam-do (KR); Jérémie AUVERGNIOT, Grenoble (FR); GyeongSeo PARK, Chungcheongnam-do (KR)

(21) Appl. No.: 18/720,748

(22) PCT Filed: Dec. 21, 2022
(86) PCT No.: PCT/EP2022/087166

§ 371 Date: Jun. 17, 2024

(30) Foreign Application Priority Data
Dec. 22, 2021 (EP) 21216814.0

(51) Int. Cl. H01M 4/62; H01M 4/02; H01M 4/04; H01M 4/525

(52) U.S. Cl. CPC H01M 4/623; H01M 4/0471; H01M 4/525; H01M 2004/021

(57) ABSTRACT

The present invention relates to a positive electrode active material for solid-state rechargeable batteries, comprising lithium, oxygen, nickel, and at least one metal selected from the group comprising manganese and cobalt, wherein characterized in that said positive electrode active material further comprises: —fluorine and has an atomic ratio of F to the total amount of Ni, Mn, and/or Co between 0.05 to 3.0, as determined by XPS analysis, and —carbon, wherein the carbon contents are from than 370 ppm to 5000 ppm, by the total weight of said positive electrode active material, as determined by a carbon analyzer.

### TECHNICAL FIELD

The present invention relates to a positive electrode active material for a solid-state rechargeable battery. More specifically, the invention relates to a positive electrode active material comprising F element for a solid-state battery, preferably wherein the solid-state battery is a polymer based solid-state battery. The present invention also relates to a method for manufacturing said positive electrode active material. Further, the present invention relates to a solid-state battery comprising said positive electrode active material.

### BACKGROUND

This invention relates to the use of single-crystalline positive electrode active material powder for solid-state rechargeable batteries comprising F.

Such a positive electrode active material comprising elemental aluminum and fluorine on the surface layer is already known, for example, from the document WO 2016/116862 A1. This document discloses a positive electrode active material comprising F, wherein F is introduced to the positive electrode active material by mixing lithium transition metal oxide with PVDF followed by heating at 375° C. The positive electrode active material prepared according to this method displayed low retention when applied in an electrochemical cell.

It is therefore an object of the present invention to provide a positive electrode active material having good electrochemical properties.

It is a further object of the present invention to provide a method for manufacturing said positive electrode active material.

It is a further object of the present invention to provide the positive electrode active material obtainable by said method.

It is a further object of the present to provide a solid-state battery comprising said positive electrode active material.

It is a further object of the present invention to provide a use of said positive electrode active material in a solid-state battery.

It is a further object of the present invention to provide a use of said solid-state battery.

### SUMMARY OF THE INVENTION

This objective is achieved by providing a positive electrode active material for solid-state batteries comprising lithium, oxygen, nickel, and at least one metal selected from the group comprising manganese and cobalt, characterized in that said positive electrode active material further comprises:
fluorine and has an atomic ratio of F to the total amount of Ni, Mn, and/or Co between 0.05 to 3.0, as determined by XPS analysis, and
carbon, wherein the carbon contents are from 370 ppm to 5000 ppm, by total weight of said positive electrode active material, as determined by carbon analyzer.

It is indeed observed that a lower total leaked capacity (Qₜₒₜₐₗ) and high retention are achieved by using a positive electrode active material according to the present invention, as illustrated by examples and supported by the results provided in Table 2.

A further aspect of the present invention is a method for manufacturing a positive electrode active material, wherein said method comprises consecutive steps of:
mixing a lithium transition metal-based oxide compound and a F containing polymer,
heating the mixture under an oxidizing atmosphere in a furnace at a temperature less than 350° C., for a time between 1 hour and 20 hours so as to obtain the positive electrode active material.

A further aspect of the present invention is the positive electrode active material obtainable by said method.

A further aspect of the present invention is a solid-state rechargeable battery comprising the positive electrode active material.

### DETAILED DESCRIPTION

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention. As used herein, the following terms have the following meanings:

The term “ppm” as used in this document means parts per million on a mass basis.

“About” as used herein refers to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the specified value, in so far, such variations are appropriate to perform in the disclosed invention. However, it is to be understood that the value to which the modifier “about” refers is itself also specifically disclosed.

The term “comprising”, as used herein and in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a composition comprising components A and B” should not be limited to compositions consisting only of components A and B. It means that with respect to the present invention, the only relevant components of the composition are A and B. Accordingly, the terms “comprising” and “including” encompass the more restrictive terms “consisting essentially of” and “consisting of”.

“A positive electrode active material” is defined as a material which is electrochemically active in a positive electrode. By active material, it must be understood a material capable to capture and release Li ions when subjected to a voltage change over a predetermined period of time.

In the following detailed description, preferred embodiments are described to enable the practice of the invention. Although the invention is described with reference to these specific preferred embodiments, it will be understood that the following examples are intended to further clarify the present invention and are nowhere intended to limit the scope of the present invention. The invention includes numerous alternatives, modifications and equivalents that are apparent from consideration of the following detailed description.

### Positive Electrode Active Material

In a first aspect, the present invention provides a positive electrode active material for solid-state rechargeable batteries, comprising lithium, oxygen, nickel, and at least one metal selected from the group comprising manganese and cobalt, characterized in that said positive electrode active material further comprises:
fluorine and has an atomic ratio of F to a total amount of Ni, Mn, and/or Co between 0.05 to 3.0, as determined by XPS analysis, and
carbon, wherein the carbon contents are from 370 ppm to 5000 ppm, by total weight of said positive electrode active material, as determined by carbon analyzer.

In certain preferred embodiments said positive electrode active material for solid-state rechargeable batteries, comprising lithium, oxygen, nickel, and at least one metal selected from the group consisting of manganese and cobalt, characterized in that said positive electrode active material further comprises:
fluorine and has an atomic ratio of F to a total amount of Ni, Mn, and/or Co between 0.05 to 3.0, as determined by XPS analysis, and
carbon, wherein the carbon contents are from 370 ppm to 5000 ppm, by total weight of said positive electrode active material, as determined by carbon analyzer.

Preferably, said positive electrode active material comprises fluorine in an amount of at least 0.05 mol %, relative to the total atomic content of Ni, Mn, Co in said material, preferably at least 0.2 mol %, more preferably at least 0.5 mol % and most preferably at least 0.7 mol %, as determined by ICP-OES. Preferably, said positive electrode active material comprises fluorine in an amount of at most 3.0 mol %, relative to the total atomic content of Ni, Mn, Co in said material, preferably at most 2.5 mol %, more preferably at most 2.0 mol % and most preferably at most 1.8 mol %, as determined by ICP-OES. Preferably said positive electrode active material comprises fluorine in an amount between 0.05 mol % and 3.0 mol %, preferably between 0.2 mol % and 2.5 mol %, more preferably between 0.5 mol % and 2.0 mol % and most preferably between 0.7 mol % and 1.8 mol %, as determined by ICP-OES.

Preferably, said positive electrode active material comprises aluminum in an amount of at least 0.01 mol %, relative to the total atomic content of Ni, Mn, Co in said material, preferably at least 0.05 mol %, more preferably at least 0.1 mol % and most preferably at least 0.2 mol %, as determined by ICP-OES. Preferably, said positive electrode active material comprises aluminum in an amount of at most 2.0 mol %, relative to the total atomic content of Ni, Mn, Co in said particles, preferably at most 1.5 mol %, more preferably at most 1.0 mol % and most preferably at most 0.8 mol %, as determined by ICP-OES. Preferably said positive electrode active material comprises aluminum in an amount between 0.01 mol % and 2.0 mol %, preferably between 0.05 mol % and 1.5 mol %, more preferably between 0.1 mol % and 1.0 mol % and most preferably between 0.2 mol % and 0.8 mol %, as determined by ICP-OES.

In a preferred embodiment, said positive electrode active material has an atomic content of nickel, relative to the total atomic content of Ni, Mn, Co in said material between 55.0 mol % to 95.0 mol %, preferably between 58.0 mol % and 90.0 mol %, more preferably between 60.0 mol % and 88.0 mol %, as determined by ICP-OES.

In a highly preferred embodiment, said positive electrode active material has an atomic content of nickel, relative to the total atomic content of Ni, Mn, Co in said material between 55.0 mol % to 75.0 mol %, preferably between 60.0 mol % and 70.0 mol %, more preferably between 61.0 mol % and 68.0 mol %.

In a highly preferred embodiment, said positive electrode active material has an atomic content of nickel, relative to the total atomic content of Ni, Mn, Co in said material between 75.0 mol % to 95.0 mol %, preferably between 78.0 mol % and 90.0 mol %, more preferably between 80.0 mol % and 88.0 mol %.

In a preferred embodiment, said positive electrode active material has an atomic content of cobalt, relative to the total atomic content of Ni, Mn, Co in said material, between 0 mol % to 40.0 mol %, preferably between 2.0 mol % and 20.0 mol %, more preferably between 3.0 mol % and 18.0 mol % and most preferably between 4.0 mol % and 10.0 mol %, as determined by ICP-OES.

In a preferred embodiment said material have an atomic content of manganese, relative to the total atomic content of Ni, Mn, Co in said material, between 0 mol % to 40.0 mol %, preferably between 2.0 mol % and 30.0 mol %, more preferably between 3.0 mol % and 25.0 mol % and most preferably between 4.0 mol % and 10.0 mol %, as determined by ICP-OES.

As appreciated by the skilled person the amount of Li, Ni, Mn, Co, F, Al measured with Inductively Coupled Plasma-Optical Emission Spectroscopy (ICP-OES). For example, but not limiting to the invention, an Agilent ICP 720-ES is used in the ICP-OES analysis. In the framework of the present invention, “atomic content” of a given element expression of a concentration means how many percent of all atoms in the concerned compound are atoms of said element. The designation mol % is equivalent to “molar percent” or “at %”. For example, but not limiting to the invention, XPS analysis is carried out with a Thermo K-α+ spectrometer (Thermo Scientific).

In a preferred embodiment, said positive electrode active material has an atomic ratio of F to the total amount of Ni, Mn, and/or Co of at least 0.1, more preferably at least 0.15, and most preferably at least 0.2, as determined by XPS analysis. Preferably, said positive electrode active material has an atomic ratio of F to the total amount of Ni, Mn, and/or Co of at most 2.5, more preferably at most 2.0, and most preferably at most 1.8, as determined by XPS analysis. Preferably, said positive electrode active material has an atomic ratio of F to the total amount of Ni, Mn, and/or Co between 0.1 and 2.5, preferably between 0.15 and 2.0, most preferably between 0.2 and 1.8, as determined by XPS analysis.

In a highly preferred embodiment, said positive electrode active material has an atomic ratio of F to the total amount of Ni, Mn, and/or Co of at least 0.1, more preferably at least 0.15, and most preferably at least 0.2, as determined by XPS analysis. Preferably, said positive electrode active material has an atomic ratio of F to the total amount of Ni, Mn, and/or Co of at most 0.8, more preferably at most 0.7, and most preferably at most 0.6, as determined by XPS analysis. Preferably, said positive electrode active material has an atomic ratio of F to the total amount of Ni, Mn, and/or Co between 0.1 and 0.8, preferably between 0.15 and 0.7, most preferably between 0.15 and 0.6, as determined by XPS analysis.

In a preferred embodiment said positive electrode active material comprises aluminum and has an atomic ratio of Al to the total amount of Ni, Mn, and/or Co of at least 0.2, preferably at least 0.4, more preferably at least 0.5, and most preferably at least 0.6, as determined by XPS analysis. Preferably, said positive electrode active material has an atomic ratio of Al to the total amount of Ni, Mn, and/or Co of at most 4.0, preferably at most 3.0, more preferably at most 2.0, and most preferably at most 1.5, as determined by XPS analysis. Preferably, said positive electrode active material has an atomic ratio of Al to the total amount of Ni, Mn, and/or Co of between 0.2 and 4.0, preferably between 0.4 and 3.0, more preferably between 0.5 and 2.0, and most preferably between 0.6 and 1.5.

In a highly preferred embodiment said positive electrode active material comprises aluminum and has an atomic ratio of Al to the total amount of Ni, Mn, and/or Co of at least 0.2, preferably at least 0.5, more preferably at least 0.7, and most preferably at least 0.9, as determined by XPS analysis. Preferably, said positive electrode active material has an atomic ratio of Al to the total amount of Ni, Mn, and/or Co of at most 1.35, preferably at most 1.30, more preferably at most 1.25, and most preferably at most 1.20, as determined by XPS analysis. Preferably, said positive electrode active material has an atomic ratio of Al to the total amount of Ni, Mn, and/or Co of between 0.2 and 1.35, preferably between 0.5 and 1.30, more preferably between 0.7 and 1.25, and most preferably between 0.9 and 1.20, as determined by XPS analysis.

In a preferred embodiment said positive electrode active material has a ratio of Al over F, wherein the Al has an atomic ratio to the total amount of Ni, Mn and/or C as determined by XPS analysis and the F has an atomic ratio to the total amount of Ni, Mn and/or Co as determined by XPS analysis, of at least 1.9, preferably of at least 3, more preferably of at least 4. In a preferred embodiment said positive electrode active material has a ratio of Al over F, wherein the Al has an atomic ratio to the total amount of Ni, Mn and/or C as determined by XPS analysis and the F has an atomic ratio to the total amount of Ni, Mn and/or Co as determined by XPS analysis, of at most 10, preferably of at most 8, more preferably of at most 6. In a preferred embodiment said positive electrode active material has a ratio of Al over F, wherein the Al has an atomic ratio to the total amount of Ni, Mn and/or C as determined by XPS analysis and the F has an atomic ratio to the total amount of Ni, Mn and/or Co as determined by XPS analysis, of between 1.9 and 10, preferably between 3 and 8, more preferably between 4 and 6.

The XPS analysis provides atomic content of elements in an uppermost layer of a particle with a penetration depth of about 10 nm from an outer boundary of the particle. The outer boundary of the particle is also referred to as “surface”. In the framework of the present invention, at % signifies atomic percentage. The at % or “atomic percent” of a given element expression of a concentration means how many percent of all atoms in the concerned compound are atoms of said element. The designation at % is equivalent to mol % or “molar percent”. For example, but not limiting to the invention, XPS analysis is carried out with a Thermo K-α+ spectrometer (Thermo Scientific).

In a preferred embodiment, said positive electrode active material comprises carbon having a content of at least 500 ppm by the total weight of said positive electrode active material, more preferably at least 600 ppm, and most preferably at least 700 ppm by the total weight of said positive electrode active material, as determined by carbon analyzer. Preferably, said positive electrode active material comprises carbon having a content of at most 3000 ppm by the total weight of said positive electrode active material, more preferably at most 2000 ppm, and most preferably at most 1500 ppm by the total weight of said positive electrode active material, as determined by carbon analyzer. Preferably said positive electrode active material comprises carbon having a content between 500 ppm and 3000 ppm by total weight of said positive electrode active material, preferably between 600 ppm and 2000 ppm, more preferably between 700 ppm and 1500 ppm by total weight of said positive electrode active material. As appreciated by the skilled person the carbon content of the positive electrode active material of the invention is measured with a carbon analyzer. For example, but not limiting to the invention, a Horiba Emia-Expert carbon/sulfur analyzer can be used to measure the carbon content.

In a preferred embodiment said positive electrode material has a median particle size (d50 or D50) between 2.0 μm to 10.0 μm, as determined by laser diffraction. For example, but not limiting to the invention, the median particle size (d50 or D50) can be measured with a Malvern Mastersizer 3000. Preferably, said median particle size is between 2.0 μm and 9.0 μm, more preferably between 3.0 μm and 8.0 μm.

In a preferred embodiment the positive electrode active material is a single-crystal powder. Alternatively, and in an equally preferred embodiment, the positive electrode active material is a poly-crystalline powder.

The concept of single-crystalline powders is well known in the technical field of positive electrode active material. It concerns powders having mostly single-crystalline particles. Such powder are a separate class of powders compared to poly-crystalline powders, which are made of particles which are mostly poly-crystalline. The skilled person can easily distinguish such these two classes of powders based on a microscopic image.

Single-crystal particles are also known in the technical field as monolithic particles, one-body particles or and mono-crystalline particles.

Even though a technical definition of a single-crystalline powder is superfluous, as the skilled person can easily recognize such a powder with the help of an SEM, in the context of the present invention, single-crystalline powders may be considered to be defined as powders in which 80% or more of the number of particles are single-crystalline particles. This may be determined on an SEM image having a field of view of at least 45 μm× at least 60 μm (i.e. of at least 2700 μm2), and preferably of: at least 100 μm×100 μm (i.e. of at least 10,000 μm2).

Single-crystalline particles are particles which are individual crystals or which are formed of a less than five, and preferably at most three, primary particles which are themselves individual crystals. This can be observed in proper microscope techniques like Scanning Electron Microscope (SEM) by observing grain boundaries. Therefore, and as appreciated by the skilled person, the determination of secondary particle median size D50 is also applicable to the single-crystalline powder.

For the determination whether particles are single-crystalline particles, grains which have a largest linear dimension, as observed by SEM, which is smaller than 20% of the median particle size D50 of the powder, as determined by laser diffraction, are ignored. This avoids that particles which are in essence single-crystalline, but which may have deposited on them several very small other grains, for instance a poly-crystalline coating, are inadvertently considered as not being single-crystalline particles.

As appreciated by the skilled person the poly-crystalline powder consist of secondary particles comprising a plurality of primary particles, preferably more than 20 primary particles, preferably more than 10 primary particles, most preferably more than 5 primary particles.

In certain preferred embodiments the positive electrode active material is according to the invention
comprising single-crystalline particles, and
having a particle median size D50 between 2.0 μm to 10.0 μm, preferably between 2.0 μm and 9.0 μm, more preferably between 3.0 μm and 8.0 μm, as determined via laser diffraction.

In certain preferred embodiments the positive electrode active material is according to the invention
comprising poly-crystalline particles, and
having a particle median size D50 between 2.0 μm to 10.0 μm, preferably between 2.0 μm and 9.0 μm, more preferably between 3.0 μm and 8.0 μm, as determined via laser diffraction.

In a preferred embodiment the source of the fluorine is an F containing polymer, preferably a F containing organic polymer, preferably polyvinylidene fluoride (PVDF) or polytetrafluoroethylene (PTFE).

In a preferred embodiment the fluorine-containing organic polymer has been heated at a temperature from 200° C. to 350° C., preferably from 250° C. to 300° C. for a time period from 1 hour to 20 hours so as to obtain the positive electrode active material.

In a preferred embodiment the positive electrode active material is a low leakage positive electrode active material.

In a further aspect the invention provides a secondary particles-based positive electrode active material for solid-state rechargeable batteries, comprising lithium, oxygen, nickel, and at least one metal selected from the group comprising manganese and cobalt, characterized in that said positive electrode active material further comprises:
fluorine and has an atomic ratio of F to a total amount of Ni, Mn, and/or Co between 0.05 to 3.0, as determined by XPS analysis, and
carbon, wherein the carbon contents are from 370 ppm to 5000 ppm, by total weight of said positive electrode active material, as determined by carbon analyzer.

In a highly preferred embodiment of the secondary particles-based positive electrode active material, all embodiments directed to the positive electrode active material according to the first aspect of the invention apply mutatis mutandis to the secondary particles-based positive electrode active material. For example, the various embodiments relating to the identity and amounts of Li, M′, F and Al as explained herein in the context of the positive electrode active material are equally applicable to the secondary particles-based positive electrode active material.

In a further aspect the invention provides a single-crystalline particles-based positive electrode active material for solid-state rechargeable batteries, comprising lithium, oxygen, nickel, and at least one metal selected from the group comprising manganese and cobalt, characterized in that said positive electrode active material further comprises:
fluorine and has an atomic ratio of F to a total amount of Ni, Mn, and/or Co between 0.05 to 3.0, as determined by XPS analysis, and
carbon, wherein the carbon contents are from 370 ppm to 5000 ppm, by total weight of said positive electrode active material, as determined by carbon analyzer.

In a highly preferred embodiment of the single-crystalline particles-based positive electrode active material, all embodiments directed to the positive electrode active material according to the first aspect of the invention apply mutatis mutandis to the single-crystalline particles-based positive electrode active material. For example, the various embodiments relating to the identity and amounts of Li, M′, F and Al as explained herein in the context of the positive electrode active material are equally applicable to the secondary particles-based positive electrode active material.

### Method for Manufacturing

In a second aspect, the present invention is also inclusive of a method for manufacturing a positive electrode active material, comprising the steps of:
mixing a lithium transition metal-based oxide compound and F containing polymer, and optionally an aluminum containing powder and
heating the mixture under an oxidizing atmosphere in a furnace at a temperature less than 350° C., for a time between 1 hour and 20 hours so as to obtain the positive electrode active material.

A highly preferred embodiment is the method for manufacturing the positive electrode active material, wherein the positive electrode active material is according to the first aspect of the invention.

In a preferred embodiment of the method the lithium transition metal-based oxide compound comprising Li, M′ and oxygen, wherein M′ comprises Ni, Mn and Co.

In a certain preferred embodiment, the lithium transition metal-based oxide used is also typically prepared according to a lithiation process, which is the process wherein a mixture of a transition metal oxide precursor and a source of lithium is heated at a temperature preferably of at least 500° C. and at most 1000° C. Typically, the transition metal precursor is prepared by coprecipitation of one or more transition metal sources, such as salts, preferably sulfates or nitrates, more preferably sulfates; of the elements Ni, Mn and/or Co, in the presence of an alkali compound, such as an alkali hydroxide e.g. sodium hydroxide and/or ammonia. Preferably, the source of lithium is metallic lithium or a lithium salt, preferably a lithium salt such as LiOH.

In a preferred embodiment the aluminum containing powder comprises Al₂O₃.

Preferably, the F containing polymer is a F containing organic polymer, preferably polyvinylidene fluoride (PVDF) or polytetrafluoroethylene (PTFE).

Preferably, the temperature of the heating the mixture is between 200° C. and 350° C., preferably between 250° C. and 300° C.

In a certain preferred embodiment the heating of the mixture is at a time more than 2 hours, preferably more than 3 hours, more preferably more than 4 hours. In a preferred embodiment the heating of the mixture is at a time less than 15 hours, preferably less than 12 hours, preferably less than 10 hours. In a preferred embodiment the heating of the mixture is at a time between 2 hours and 15 hours, preferably between 3 hours and 12 hours, more preferably between 4 hours and 10 hours.

A preferred embodiment of the method is the heating the mixture, wherein the oxidizing atmosphere comprises oxygen, such as air, or consists of oxygen.

### Positive Electrode Active Material Obtainable by the Method

In a third aspect, the present invention provides a positive electrode active material obtainable by the method according to the second aspect of the invention.

As appreciated by the skilled person all embodiments directed to the positive electrode active material according to the first aspect of the invention and/or the method according to the second aspect of the invention apply mutatis mutandis to the positive electrode active obtainable by the method according to the invention. For example, the various embodiments relating to the identity and amounts of F, Al, Ni, Mn, and Co as explained herein in the context of the positive electrode active material are equally applicable to the positive electrode active material obtainable by the method for the preparation of the positive electrode active material.

### Battery

In a fourth aspect the present invention concerns a battery comprising the positive electrode active material according to the first aspect of the invention and/or according to the third aspect of the invention.

In a preferred embodiment the battery is a solid-state battery. Preferably the solid-state battery comprises a polymer-based electrolyte. Preferably said electrolyte is a polyethylene oxide based solid electrolyte, more preferably the electrolyte comprises polyethylene oxide.

Preferably, the solid-state battery further comprises an anode comprising anode active material. Suitable electrochemically active anode materials are those known in the art. For example, the anode may comprise graphitic carbon, metallic lithium, such as a lithium foil, or a metal alloy comprising lithium, such as Li—In alloy, as the anode active material.

In a preferred embodiment the battery according to the invention comprises a positive electrode active material being a poly-crystalline material having a retention of at least 87%, preferably at least 88%, most preferably at least 89%. Alternatively, and in an equally preferred embodiment, the battery according to the invention comprises a positive electrode active material being a single-crystal material having a retention of at least 98%, more preferably at least 99%, most preferably at least 100%. As appreciated by the skilled person the retention of the battery is determined as explained under point 1.3.2 of the Examples.

In certain preferred embodiments the retention is defined as DQ2/DQ1×100%. In certain more preferred embodiments, the retention is defined by a coin cell testing procedure in a coin-type polymer cell cycled at 80° C. using a Toscat-3100 computer-controlled galvanostatic cycling stations (Toyo) uses a 1 C current definition of 160 mA/g in the 4.4-3.0 V/Li metal window range according to the schedule below:
Step 1) Charging in a constant current mode with C-rate of 0.05 with an end condition of 4.4 V followed by 10 minutes rest.
Step 2) Discharging in a constant current mode with C-rate of 0.05 with an end condition of 3.0 V followed by 10 minutes rest. Discharge capacity of this step is DQ1.
Step 3) Charging in a constant current mode with C-rate of 0.05 with an end condition of 4.4 V.
Step 4) Switching to a constant voltage mode and keeping 4.4 V for 60 hours.
Step 5) Discharging in a constant current mode with C-rate of 0.05 with an end condition of 3.0 V. Discharge capacity of this step is DQ2.

In a preferred embodiment the battery according to the invention comprises a positive electrode active material being a poly-crystalline material having a Qₜₒₜₐₗ of less than 78 mAh/g, preferably less than 75 mAh/g, more preferably less than 70 mAh/g. Alternatively, and in an equally preferred embodiment, the battery according to the invention comprises a positive electrode active material being a single-crystal material having Qₜₒₜₐₗ of less than 70 mAh/g, preferably less than 45 mAh/g, more preferably less than 40 mAh/g, even more preferably less than 32 mAh/g, most preferably less than 32 mAh/g. As appreciated by the skilled person the Qₜₒₜₐₗ of the battery is determined as explained under point 1.3.2 of the Examples.

In certain preferred embodiments the Qₜₒₜₐₗ is defined is defined as the total leaked capacity, preferably at the high voltage and high temperature. In certain more preferred embodiments, Qₜₒₜₐₗ is defined as the total leaked capacity at the high voltage and high temperature in the Step 4) according to the following described testing method, preferably the Qₜₒₜₐₗ is defined by a coin cell testing procedure in a coin-type polymer cell cycled at 80° C. using a Toscat-3100 computer-controlled galvanostatic cycling stations (Toyo) uses a 1 C current definition of 160 mA/g in the 4.4-3.0 V/Li metal window range according to the schedule below:
Step 1) Charging in a constant current mode with C-rate of 0.05 with an end condition of 4.4 V followed by 10 minutes rest.
Step 2) Discharging in a constant current mode with C-rate of 0.05 with an end condition of 3.0 V followed by 10 minutes rest. Discharge capacity of this step is DQ1.
Step 3) Charging in a constant current mode with C-rate of 0.05 with an end condition of 4.4 V.
Step 4) Switching to a constant voltage mode and keeping 4.4 V for 60 hours.

### Use

In a fourth aspect, the present invention provides a use of the positive electrode active material according to the first aspect of the invention and/or according to the third aspect of the invention in a battery

A preferred embodiment is the use of the positive electrode active material in a battery, preferably a solid-state-battery, more preferably a polymer solid-state-battery, to increase the retention of the battery.

A preferred embodiment is the use of the positive electrode active material in a battery, preferably a solid-state-battery, more preferably a sulfide solid-state-battery, to reduce the leakage of the battery.

In a fifth aspect the present invention concerns a use of the battery according to invention in either one of a portable computer, a tablet, a mobile phone, an energy storage system, an electric vehicle or in a hybrid electric vehicle, preferably in an electric vehicle or in a hybrid electric vehicle.

### EXAMPLES

### 1. Description of Analysis Method

### 1.1. Inductively Coupled Plasma

The composition of a positive electrode active material powder is measured by the inductively coupled plasma (ICP) method using an Agilent 720 ICP-OES. 1 gram of powder sample is dissolved into 50 mL of high purity hydrochloric acid (at least 37 wt. % of HCl with respect to the total weight of solution) in an Erlenmeyer flask. The flask is covered by a watch glass and heated on a hot plate at 380° C. until the powder is completely dissolved. After being cooled to room temperature, the solution from the Erlenmeyer flask is poured into a first 250 ml volumetric flask. Afterwards, the first volumetric flask is filled with deionized water up to the 250 mL mark, followed by a complete homogenization process (1^{st} dilution). An appropriate amount of the solution from the first volumetric flask is taken out by a pipette and transferred into a second 250 mL volumetric flask for the 2nd dilution, where the second volumetric flask is filled with an internal standard element and 10% hydrochloric acid up to the 250 ml mark and then homogenized. Finally, this solution is used for ICP measurement.

### 1.2. Particle Size Distribution

The particle size distribution (PSD) of the positive electrode active material powder is measured by laser diffraction particle size analysis using a Malvern Mastersizer 3000 with a Hydro MV wet dispersion accessory after having dispersed each of the powder samples in an aqueous medium. In order to improve the dispersion of the powder, sufficient ultrasonic irradiation and stirring are applied, and an appropriate surfactant is introduced. D50 is defined as the particle size at 50% of the cumulative volume % distributions obtained from the Malvern Mastersizer 3000 with Hydro MV measurements.

### 1.3. Polymer Cell Test

### 1.3.1. Polymer Cell Preparation

### 1.3.1.1. Solid Polymer Electrolyte (SPE) Preparation

A solid polymer electrolyte (SPE) is prepared according to the process as follows:
Step 1) Mixing polyethylene oxide (PEO, 1,000,000 g/mol, Alfa Aesar) with lithium bis(trifluoromethanesulfonyl)imide salt (LiTFSI, >98.0%, TCI) in acetonitrile anhydrous 99.8 wt % (Aldrich), using a mixer for 30 minutes at 2,000 revolutions per minute (rpm). The mass ratio of polyethylene oxide to LiTFSI is 3.0.
Step 2) Pouring the mixture from Step 1) into a Teflon dish and drying at 25° C. for 12 hours.
Step 3) Detaching the dried SPE from the dish and punching the dried SPE in order to obtain SPE disks having a thickness of 300 μm and a diameter of 19 mm.

### 1.3.1.2. Positive Electrode Preparation

A positive electrode is prepared according to the process as follows:
Step 1) Preparing a polymer electrolyte mixture comprising polyethylene oxide (PEO, 100,000 g/mol, Alfa Aesar) solution in anisole anhydrous 99.7 wt % (Sigma-Aldrich) and Lithium bis(trifluoromethanesulfonyl)imide salt (LiTFSI, >98.0%, TCI) in acetonitrile. The mixture has a ratio of PEO:LiTFSI of 74:26 by weight.
Step 2) Mixing the polymer electrolyte mixture prepared from Step 1) with a positive electrode active material and a conductor powder (Super P, Timcal) in acetonitrile solution with a ratio of 21:75:4 by weight so as to prepare a slurry mixture. The mixing is performed by a homogenizer for 45 minutes at 5,000 rpm.
Step 3) Casting the slurry mixture from Step 2) on one side of a 20 μm-thick aluminum foil with 100 μm coater gap.
Step 4) Drying the slurry-casted foil at 30° C. for 12 hours followed by punching in order to obtain catholyte electrodes having a diameter of 14 mm.

### 1.3.1.3. Negative Electrode Preparation

A Li foil (diameter 16 mm, thickness 500 μm) is prepared as a negative electrode.

### 1.3.1.4. Polymer Cell Assembling

The coin-type polymer cell is assembled in an argon-filled glovebox with an order from bottom to top: a 2032 coin cell can, a positive electrode prepared from section 1.3.1.2, a SPE prepared from section 1.3.1.1, a gasket, a negative electrode prepared from section 1.3.1.3, a spacer, a wave spring, and a cell cap. Then, the coin cell is completely sealed to prevent leakage of the electrolyte.

### 1.3.2. Testing Method

Each coin-type polymer cell is cycled at 80° C. using a Toscat-3100 computer-controlled galvanostatic cycling stations (Toyo). The coin cell testing procedure uses a 1 C current definition of 160 mA/g in the 4.4-3.0 V/Li metal window range according to the schedule below:
Step 1) Charging in a constant current mode with C-rate of 0.05 with an end condition of 4.4 V followed by 10 minutes rest.
Step 2) Discharging in a constant current mode with C-rate of 0.05 with an end condition of 3.0 V followed by 10 minutes rest. Discharge capacity of this step is DQ1.
Step 3) Charging in a constant current mode with C-rate of 0.05 with an end condition of 4.4 V.
Step 4) Switching to a constant voltage mode and keeping 4.4 V for 60 hours.
Step 5) Discharging in a constant current mode with C-rate of 0.05 with an end condition of 3.0 V. Discharge capacity of this step is DQ2.

Qₜₒₜₐₗ is defined as the total leaked capacity at the high voltage and high temperature in the Step 4) according to the described testing method. A low value of Qₜₒₜₐₗ indicates a high stability of the positive electrode active material powder during a high temperature operation.

$$Retention is calculated as \frac{DQ 2}{DQ 1} \times 100 \% .$$

### 1.4. X-Ray Photoelectron Spectroscopy (XPS)

In the present invention, X-ray photoelectron spectroscopy (XPS) is used to analyze the surface of positive electrode active material powder particles. In XPS measurement, the signal is acquired from the first few nanometers (e.g., 1 nm to 10 nm) of the uppermost part of a sample, i.e., surface layer. Therefore, all elements measured by XPS are contained in the surface layer.

For the surface analysis of positive electrode active material powder particles, XPS measurement is carried out using a Thermo K-α+ spectrometer. Monochromatic Al Kα radiation (hu=1486.6 eV) is used with a spot size of 400 μm and measurement angle of 45°. A wide survey scan to identify elements present at the surface is conducted at 200 eV pass energy. C1s peak having a maximum intensity (or centered) at a binding energy of 284.8 eV is used as a calibrate peak position after data collection. Accurate narrow scans are performed afterwards at 50 eV for at least 10 scans for each identified element to determine the precise surface composition.

Curve fitting is done with CasaXPS Version2.3.19PR1.0 using a Shirley-type background treatment and Scofield sensitivity factors. The fitting parameters are according to Table 2a.

Line shape GL (30) is the Gaussian/Lorentzian product formula with 70% Gaussian line and 30% Lorentzian line. LA(α, β, m) is an asymmetric line-shape where α and β define tail spreading of the peak and m define the width.

TABLE 1a
XPS fitting parameter for Ni2p3, Mn2p3, Co2p3, Al2p, and F1s.

| | Sensitivity | Fitting range | | |
|---|---|---|---|---|
| Element | factor | (eV) | Defined peak(s) | Line shape |
| Ni | 14.61 | 851.1 ± 0.1- | Ni2p3, Ni2p3 satellite | LA(1.33, |
| | | 868.7 ± 0.1 | | 2.44, 69) |
| Mn | 9.17 | 639.9 ± 0.1- | Mn2p3, Mn2p3 satellite | GL(30) |
| | | 649.5 ± 0.1 | | |
| Co | 12.62 | 775.4 ± 0.1- | Co2p3, Co2p3 satellite | LA(1.33, |
| | | 792.0 ± 0.3 | | 2.44, 69) |
| Al | 0.54 | 78.7 ± 0.1- | Al2p peak, Ni3p1, | GL(30) |
| | | 66.0 ± 0.1 | Ni3p3, Ni3p1 satellite, | |
| | | | Ni3p3 satellite | |
| F | 4.43 | 639.5 ± 0.1- | F1s-1, F1s-2 | GL(30) |
| | | 682.0 ± 0.1 | | |

For Al and Co peaks, constraints are set for each defined peak according to Table 2b. All Ni3p peak related is not quantified.

TABLE 1b
XPS fitting constraints for Al2p and Co2p peak fitting.

| | | Fitting range | FWHM | |
|---|---|---|---|---|
| Element | Defined peak | (eV) | (eV) | Area |
| Al | Ni3p3 | 66.0-68.0 | 0.5-2.9 | No constraint set |
| | Ni3p1 | 68.0-70 | Equal to | 50% of Ni3p3 area |
| | | | Ni3p3 | |
| | Ni3p3 satellite | 70.5-72.0 | 0.5-2.9 | 40% of Ni3p3 area |
| | Ni3p1 satellite | 72.5-73.5 | 0.5-2.9 | 20% of Ni3p3 area |
| | Al2p peak | 73.5-76.0 | 0.5-3.0 | No constraint set |
| Co | Co2p3 | 778.0-782.0 | 0.5-4.0 | No constraint set |
| | Co2p3 satellite | 789.0-792.0 | 0.5-4.0 | No constraint set |

The Al and F surface contents as determined by XPS are expressed as atomic fractions of Al and F, respectively, in the surface layer of the particles divided by the total content of Ni, Mn, and Co, in said surface layer. It is calculated as follows:

$$atomic ratio of Al to Ni , Mn , and Co by XPS = \frac{Al ( at . \% )}{Ni + Mn + Co ( at . \% )}$$

$$atomic ratio of F to Ni , Mn , and Co by XPS = \frac{F ( at . \% )}{Ni + Mn + Co ( at . \% )}$$

### 1.5. Carbon Analysis

The content of carbon of the positive electrode active material powder is measured by Horiba Emia-Expert carbon/sulfur analyzer. 1 gram of the positive electrode active material powder is placed in a ceramic crucible in a high frequency induction furnace. 1.5 grams of tungsten and 0.2 grams of tin are added into the crucible as accelerators. The powder is heated at a programmable temperature wherein gases produced during the combustion are then analyzed by Infrared detectors. The analysis of CO₂ and CO determines the carbon concentration.

### 2. Examples and Comparative Examples

### Comparative Example 1

A single-crystalline positive electrode active material labelled as CEX1 was prepared according to the following steps:
Step 1) Transition metal oxidized hydroxide precursor preparation: A nickel-based transition metal oxidized hydroxide powder (TMH1) having a metal composition of Ni_{0.63}Mn_{0.22}Co_{0.15} Was prepared by a co-precipitation process in a large-scale continuous stirred tank reactor (CSTR) with mixed nickel manganese cobalt sulphates, sodium hydroxide, and ammonia.
Step 2) First mixing: The TMH1 prepared from Step 1) was mixed with Li₂CO₃ in an industrial blender to obtain a first mixture having a lithium to metal (Ni, Mn, and Co) ratio of 0.85.
Step 3) First heating: The first mixture from Step 2) was heated at 900° C. for 10 hours under dry air atmosphere to obtain a first heated cake.
Step 4) Second mixing: The first heated cake from Step 3) was mixed with LiOH in an industrial blender to obtain a second mixture having a lithium to metal (Ni, Mn, and Co) ratio of 1.05.
Step 5) Second heating: The second mixture from Step 4) was heated at 950° C. for 10 hours under dry air atmosphere, followed by wet milling, drying, and sieving process to obtain a second heated product.
Step 6) Third mixing: The second heated product from Step 5) was mixed with 2 mol % of Co from Co₃O₄ and 5 mol % of Li from LiOH, each with respect to the total atomic contents of Ni, Mn, and Co to obtain a third mixture.
Step 7) Third heating: The third mixture from Step 6) was heated at 775° C. for 12 hours under dry air atmosphere to obtain CEX1 comprising Ni, Mn, and Co in a ratio Ni:Mn:Co of 0.61:0.22:0.17 as obtained by ICP-OES. CEX1 has a D50 of 7 μm.

Due to the wet milling in step 5), CEX1 is a single-crystalline powder.

### Example 1

A single-crystalline positive electrode active material labelled as EX1 was prepared according to the following steps:
Step 1) Mixing: CEX1 was mixed with 3000 ppm of PTFE and 2000 ppm of alumina nano-powder in a mixer.
Step 2) Heating: The mixture obtained from Step 1) was heated at 250° C. for 6 hours under oxygen atmosphere followed by milling to obtain EX1.

### Comparative Example 2

A single-crystalline positive electrode active material labelled as CEX2.1 was prepared according to the following steps:
Step 1) Transition metal oxidized hydroxide precursor preparation: A nickel-based transition metal oxidized hydroxide powder (TMH2) having a metal composition Ni_{0.86}Mn_{0.07}Co_{0.07} Was prepared by a co-precipitation process in a large-scale continuous stirred tank reactor (CSTR) with mixed nickel manganese cobalt sulfates, sodium hydroxide, and ammonia.
Step 2) Precursor oxidation: The TMH2 prepared from Step 1) was heated at 400° C. for 7 hours under an oxidizing atmosphere to obtain a heated product.
Step 3) First mixing: The heated product prepared from Step 2) was mixed with LiOH in an industrial blender to obtain a first mixture having a lithium to metal (Ni, Mn, and Co) ratio of 0.96.
Step 4) First heating: The first mixture from Step 3) was heated at 890° C. for 11 hours under an oxidizing atmosphere to obtain a first heated product.
Step 5) Wet bead milling: The first heated product from Step 4) was bead milled in a solution containing 0.5 mol % of Co with respect to the total atomic contents of Ni, Mn, and Co in the first heated product followed by drying and sieving process to obtain a milled product. The bead milling solid to solution weight ratio is 6:4 and was conducted for 20 minutes.
Step 6) Second mixing: The milled product obtained from Step 5) was mixed in an industrial blender with 1.5 mol % Co from Co₃O₄, 0.25 mol % Zr from ZrO₂, and 7.5 mol % Li from LiOH, each with respect to the total atomic contents of Ni, Mn, and Co in the milled product to obtain a second mixture.
Step 7) Second heating: The second mixture from Step 6) was heated at 760° C. for 10 hours under an oxidizing atmosphere followed by crushing and sieving process together with 500 ppm of Al from alumina (Al₂O₃) powder. The final product is CEX2.1 comprising Ni, Mn, and Co in a ratio Ni:Mn:Co of 0.84:0.07:0.09 as obtained by ICP-OES. CEX2.1 has a D50 of 4 μm.

A single-crystalline positive electrode active material labelled as CEX2.2 was prepared according to the following steps:
Step 1) Mixing: CEX2.1 was mixed with 3000 ppm of PVDF and 2000 ppm of alumina nano-powder in a mixer.
Step 2) Heating: The mixture obtained from Step 1) was heated at 350° C. for 6 hours under oxygen atmosphere followed by milling to obtain CEX2.2.

CEX2.3 was prepared according to the same method as CEX2.2, except that PTFE was used instead of PVDF in Step 1).

CEX2.4 was prepared according to the same method as CEX2.2, except that PTFE was used instead of PVDF in Step 1) and 450° C. heating was applied in step 2).

### Example 2

A single-crystalline positive electrode active material labelled as EX2.1 was prepared according to the following steps:
Step 1) Mixing: CEX2.1 was mixed with 3000 ppm of PVDF and 2000 ppm of alumina nano-powder in a mixer.
Step 2) Heating: The mixture obtained from Step 1) was heated at 200° C. for 6 hours under oxygen atmosphere followed by milling to obtain EX2.1.

EX2.2 was prepared according to the same method as EX2.1 except that the heating temperature in Step 2) was 250° C.

EX2.3 was prepared according to the same method as EX2.1 except that the heating temperature in Step 2) was 300° C.

EX2.4 was prepared according to the same method as EX2.1 except that alumina was not added and PTFE was used instead of PVDF in Step 1). Furthermore, heating was not applied in Step 2).

EX2.5 was prepared according to the same method as EX2.1 except that alumina was not added and PTFE was used instead of PVDF in Step 1). Furthermore, 250° C. heating was applied in Step 2).

EX2.6 was prepared according to the same method as EX2.1 except that PTFE was used instead of PVDF in Step 1) and heating was not applied in Step 2).

EX2.7 was prepared according to the same method as EX2.1 except that PTFE was used instead of PVDF in Step 1).

EX2.8 was prepared according to the same method as EX2.1 except that PTFE was used instead of PVDF in Step 1) and 250° C. heating was applied in Step 2).

EX2.9 was prepared according to the same method as EX2.1 except that PTFE was used instead of PVDF in Step 1) and 300° C. heating was applied in Step 2).

### Comparative Example 3

A single-crystalline positive electrode active material labelled as CEX3 was prepared according to the following steps:
Step 1) Transition metal oxidized hydroxide precursor preparation: A nickel-based transition metal oxidized hydroxide powder (TMH3) having a metal composition Ni_{0.90}Mn_{0.05}Co_{0.05} was prepared by a co-precipitation process in a large-scale continuous stirred tank reactor (CSTR) with mixed nickel manganese cobalt sulfates, sodium hydroxide, and ammonia.
Step 2) First mixing: The TMH3 prepared from Step 1) was mixed with LiOH and ZrO₂ in an industrial blender to obtain a first mixture having a lithium to metal (Ni, Mn, and Co) ratio of 0.99 and 1000 ppm of Zr.
Step 3) First heating: The first mixture from Step 2) was heated at 890° C. for 11 hours under an oxidizing atmosphere to obtain a first heated product.
Step 4) Wet bead milling: The first heated product from Step 3) was bead milled in a solution containing 0.5 mol % of Co with respect to the total atomic contents of Ni, Mn, and Co in the first heated product followed by drying and sieving process to obtain a milled product. The bead milling solid to solution weight ratio is 6:4 and was conducted for 20 minutes.
Step 5) Second mixing: The milled product obtained from Step 4) was mixed in an industrial blender with 1.5 mol % of Co from Co₃O₄ and 1000 ppm of Zr from ZrO₂ with respect to the total atomic contents of Ni, Mn, and Co in the milled product to obtain a second mixture.
Step 6) Second heating: The second mixture from Step 5) was heated at 760° C. for 12 hours under an oxidizing atmosphere followed by crushing and sieving process together with 500 ppm of Al from alumina (Al₂O₃) powder. The product is CEX3 comprising Ni, Mn, and Co in a ratio Ni:Mn:Co of 0.88:0.05:0.07 as obtained by ICP-OES. CEX3 has a D50 of 4 μm.

### Example 3

A single-crystalline positive electrode active material labelled as EX3 was prepared according to the following steps:
Step 1) Mixing: CEX3 was mixed with 3000 ppm of PTFE and 2000 ppm of alumina nano-powder in a mixer.
Step 2) Heating: The mixture obtained from Step 1) was heated at 250° C. for 6 hours under oxygen atmosphere followed by milling to obtain EX3.

### Comparative Example 4

A poly-crystalline positive electrode active material labelled as CEX4 was prepared according to the following steps:
Step 1) Transition metal oxidized hydroxide precursor preparation: A nickel-based transition metal oxidized hydroxide powder (TMH4) having a metal composition Ni_{0.83}Mn_{0.12}Co_{0.05} Was prepared by a co-precipitation process in a large-scale continuous stirred tank reactor (CSTR) with mixed nickel manganese cobalt sulfates, sodium hydroxide, and ammonia.
Step 2) First mixing: The TMH4 prepared from Step 1) was mixed with LiOH in an industrial blender to obtain a first mixture having a lithium to metal (Ni, Mn, and Co) ratio of 0.975.
Step 3) First heating: The first mixture from Step 2) was heated at 765° C. for 10 hours under an oxidizing atmosphere to obtain a first heated product followed by milling and sieving.
Step 4) Second mixing: The first heated product from Step 3) and LiOH as a lithium source were homogenously mixed with a lithium to metal (Ni, Mn, and Co) ratio of 1.03 in an industrial blending equipment to obtain a second mixture.
Step 5) Second heating: The second mixture from Step 4) was heated at 770° C. for 12 hours under an oxygen atmosphere to obtain a CEX4 comprising Ni, Mn, and Co in a ratio Ni:Mn:Co of 0.83:0.12:0.05 as obtained by ICP-OES. CEX4 has a D50 of 6 μm.

### Example 4

A poly-crystalline positive electrode active material labelled as EX4.1 was prepared according to the following steps:
Step 1) Mixing: CEX4 was mixed with 2000 ppm of PTFE and 2000 ppm of alumina nano-powder in a mixer
Step 2) Heating: The mixture obtained from Step 1) was heated at 250° C. for 6 hours under oxygen atmosphere followed by milling to obtain EX4.1.

EX4.2 was prepared according to EX4.1 except that 3000 ppm PTFE was used in Step 1).

EX4.3 was prepared according to EX4.1 except that 4000 ppm PTFE was used in Step 1).

TABLE 2
Summary of the composition and the corresponding electrochemical
properties of examples and comparative examples

| | F | Heating | | | | | | | Solid-state battery | |
|---|---|---|---|---|---|---|---|---|---|---|
| | containing | t | Carbon | ICP * (mol %) | | | XPS** | | Q total | Retention |
| ID | polymer | (° C.) | (ppm) | Ni | F | Al | Al | F | (mAh/g) | (%) |
| CEX1 | n.a. | n.a. | 134 | 61 | n.a. | n.a. | n.a. | n.a. | 74.9 | 93.5 |
| EX1 | PTFE | 250 | 839 | 61 | 1.2 | 0.4 | n.a. | n.a. | 48.4 | 99.1 |
| CEX2.1 | n.a. | n.a. | 330 | 84 | n.a. | 0.1 | n.a. | n.a. | 39.6 | 96.8 |
| CEX2.2 | PVDF | 350 | 69 | 84 | 1.1 | 0.5 | n.a. | n.a. | 32.4 | 94.6 |
| CEX2.3 | PTFE | 350 | 330 | 84 | 1.2 | 0.5 | 0.80 | 1.23 | 44.0 | 95.6 |
| CEX2.4 | PTFE | 450 | 350 | 84 | 1.2 | 0.5 | 0.90 | 1.69 | 50.8 | 94.8 |
| EX2.1 | PVDF | 200 | 1358 | 84 | 1.1 | 0.5 | 0.95 | 0.36 | 29.7 | 99.4 |
| EX2.2 | PVDF | 250 | 1199 | 84 | 1.1 | 0.5 | 0.94 | 0.57 | 36.2 | 99.3 |
| EX2.3 | PVDF | 300 | 753 | 84 | 1.1 | 0.5 | 0.61 | 0.81 | 31.1 | 98.9 |
| EX2.4 | PTFE | n.a. | 1077 | 84 | 1.2 | 0.1 | 0.43 | 0.48 | 34.3 | 98.3 |
| EX2.5 | PTFE | 250 | 1119 | 84 | 1.2 | 0.1 | 0.43 | 0.52 | 34.6 | 98.3 |
| EX2.6 | PTFE | n.a. | 1086 | 84 | 1.2 | 0.5 | 0.94 | 0.26 | 35.6 | 99.3 |
| EX2.7 | PTFE | 200 | 1172 | 84 | 1.2 | 0.5 | 1.17 | 0.24 | 30.2 | 100.0 |
| EX2.8 | PTFE | 250 | 1178 | 84 | 1.2 | 0.5 | 1.09 | 0.27 | 37.6 | 99.8 |
| EX2.9 | PTFE | 300 | 877 | 84 | 1.2 | 0.5 | 1.05 | 0.54 | 28.2 | 98.6 |
| CEX3 | n.a. | 250 | 302 | 88 | n.a. | 0.2 | n.a. | n.a. | 46.8 | 96.5 |
| EX3 | PTFE | 250 | 1051 | 88 | 1.2 | 0.6 | 1.16 | 0.52 | 39.6 | 97.2 |
| CEX4 | n.a. | n.a. | 426 | 83 | n.a. | 0.05 | n.a. | n.a. | 79.0 | 84.7 |
| EX4.1 | PTFE | 250 | 1441 | 83 | 0.8 | 0.45 | 0.91 | 0.39 | 66.3 | 89.4 |
| EX4.2 | PTFE | 250 | 1613 | 83 | 1.2 | 0.45 | 0.87 | 0.52 | 66.0 | 87.2 |
| EX4.3 | PTFE | 250 | 1876 | 83 | 1.5 | 0.45 | 0.90 | 0.50 | 65.1 | 89.0 |

* calculated versus the total atomic fraction of Ni, Mn, and Co as analyzed by ICP-OES
**calculated versus the total atomic fraction of Ni, Mn, and Co as analyzed by XPS
n.a: not available

Table 2 summarizes the composition of examples and comparative examples and their corresponding electrochemical properties.

CEX1 and EX1 are single-crystalline positive electrode active material comprising around 61 mol % of Ni. EX1 further comprising F and Al results in a reduced Qₜₒₜₐₗ and retention improvement in comparison with CEX1.

CEX2.1˜CEX2.5 and EX2.1˜EX2.9 are single-crystalline positive electrode active material comprising around 84 mol % of Ni. CEX2.1 is positive electrode active material without F. CEX2.2˜CEX2.4 are mixtures of CEX2.1 with F-containing polymer, either PVDF or PTFE, and heated at temperature ≥350° C. It is observed that such heating treatment results in the positive electrode active material having high Qₜₒₜₐₗ and low retention. It is likely that the F-containing polymer is decomposed at temperature ≥350° C. indicated by low carbon content under 350 ppm. On the other hand, EX2.1˜EX2.9, are heat treated at temperature ≤300° C. All said examples show improved electrochemical properties in comparison with CEX2.1˜CEX2.4.

CEX3 and EX3 are single-crystalline positive electrode active material comprising around 88 mol % of Ni. EX3 comprising F and Al has improved electrochemical properties in comparison with CEX3.

CEX4 and EX4.1˜EX4.3 are polycrystalline positive electrode active material comprising around 88 mol % of Ni. EX4.1˜EX4.3 are obtained from CEX4 mixed with alumina, various amount of PTFE, and heated at 250° C. It is shown that EX4 demonstrates the lower Q total and higher retention in comparison with CEX4.

Table 2 also summarizes the XPS analysis results of CEX2.3, CEX2.4, EX2.6, EX2.7, EX2.8, EX2.9 showing Al and F fraction with respect to the total atomic fraction of Ni, Mn, and Co. The value higher than 0 indicates that Al or F is present on the surface of the positive electrode active material as associated with the XPS measurement which signal is acquired from the first few nanometers (e.g. 1 nm to 10 nm) of the uppermost part of a sample, i.e. surface layer.

It is concluded that the positive electrode active material comprising F and C is suitable to meet the objective of this invention: to provide a positive electrode active material having good electrochemical properties, indicated by low total leaked capacity (Qₜₒₜₐₗ) and high retention in the solid-state rechargeable battery.

1-18. (canceled)

19. A positive electrode active material for solid-state rechargeable batteries, comprising lithium, oxygen, nickel, and at least one metal selected from the group comprising manganese and cobalt, characterized in that said positive electrode active material further comprises:
fluorine and has an atomic ratio of F to the total amount of Ni, Mn, and/or Co between 0.05 to 3.0, as determined by XPS analysis, and
carbon, wherein the carbon contents are from 370 ppm to 5000 ppm, by the total weight of said positive electrode active material, as determined by a carbon analyzer.

20. The positive electrode active material according to claim 19, wherein said positive electrode active material has an atomic ratio of F to the total amount of Ni, Mn, and/or Co between 0.1 to 2.5, as determined by XPS analysis.

21. The positive electrode active material according to claim 19, wherein the carbon contents are more than 500 ppm and less than 3000 ppm, as determined by a carbon analyzer.

22. The positive electrode active material according to claim 19, further comprising aluminum and having an atomic ratio of Al to the total amount of Ni, Mn, and/or Co between 0.2 to 4.0, as determined by XPS analysis.

23. The positive electrode active material according to claim 19, further comprising aluminum in an amount between 0.01 mol % and 2.0 mol %, relative to the total atomic content of Ni, Mn, Co in said material, as determined by ICP-OES.

24. The positive electrode active material according to claim 19, wherein an atomic content of nickel, relative to the total atomic content of Ni, Mn, Co in said material is from 55.0 to 95.0 mol %, as determined by ICP-OES.

25. The positive electrode active material according to claim 19, wherein an atomic content of cobalt, relative to the total atomic content of Ni, Mn, Co in said material is from 0 to 40.0 mol %, as determined by ICP-OES.

26. The positive electrode active material according to claim 19, wherein an atomic content of manganese, relative to the total atomic content of Ni, Mn, Co in said material is from 0 to 40.0 mol %, as determined by ICP-OES.

27. The positive electrode active material according to claim 19, wherein the positive electrode active material comprises single-crystalline particles.

28. The positive electrode active material according to claim 27, wherein the single-crystalline particles have a median particle size D50_{A} from 2.0 μm to 10.0 μm, as determined by laser diffraction particle size analysis.

29. The positive electrode active material according to claim 19, wherein the positive electrode active material comprises poly-crystalline particles.

30. The positive electrode active material according to claim 29, wherein the poly-crystalline particles have a median particle size D50_{A} from 2.0 μm to 10.0 μm, as determined by laser diffraction particle size analysis.

31. A method for manufacturing a positive electrode active material, wherein said method comprises consecutive steps of:
mixing a lithium transition metal-based oxide compound and F-containing polymer,
heating the mixture under an oxidizing atmosphere in a furnace at a temperature less than 350° C., for a time between 1 hour and 20 hours to obtain the positive electrode active material.

32. The method according to claim 31, wherein the F-containing polymer is polyvinylidene fluoride (PVDF) or polytetrafluoroethylene (PTFE).

33. The method according to claim 31, wherein the heating temperature is between 200° C. and 350° C.

34. The method according to claim 31, wherein the positive electrode active material is according to claim 19.

35. A solid-state battery comprising the positive electrode material according to claim 19.

36. A portable computer, a tablet, a mobile phone, energy storage system, electric vehicle, or a hybrid electric vehicle comprising the solid-state rechargeable battery according to claim 35.
